(19) United States
(12) Patent Application Publication
(10) Pub. No.: US 2008/0239949 A1
(43) Pub. Date: Oct. 2, 2008

(54) LOAD-BALANCED CELL SWITCH DEVICE AND PRIORITY CONTROL METHOD

(75) Inventor: HIDEKI NISHIZAKI, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 12/054,867

(22) Filed: Mar. 25, 2008

(30) Foreign Application Priority Data
Mar. 28, 2007 (JP) 2007-083947

(51) Int. Cl. H04L 12/26; H04L 12/28; H04L 12/56

(52) U.S. Cl. 370/230; 370/412; 370/395.42; 370/394

(57) ABSTRACT

In cell read from a buffer for each priority provided in the intermediate stage buffers 1-5-1-1-5-N, cells can be read even from a low priority buffer within a fixed time period and at the output interfaces 1-12-1-1-12-N, cell arrival can be monitored individually on a priority basis and on a basis of each of the input interfaces 1-1-1-1-1-N while taking a cell reading cycle at the intermediate stage buffer into consideration.

### TECHNICAL FIELD

The present invention relates to a load-balanced cell switch device and, more particularly, to a load- balanced cell switch device and a priority control method thereof.

### BACKGROUND ART

As a common fixed-length cell (including a variable length packet formed into a fixed-length cell) switch whose representative is a router, there exists an input buffer type switch with a buffer provided at each input port of a crossbar switch and a scheduler for arbitrating data output from each input port.

FIG. 3 shows an example of a structure of an input buffer type switch having three input ports and three output ports. Illustrated here is an example where a cell A is input through an input 1, a cell B through an input 2 and a cell C through an input 3, which are output to outputs 1, 2 and 3, respectively. Each cell applied to each input is stored in a relevant destination queue of VOQ (Virtual Output Queue) 6-1-1-6-1-3. Each input notifies a scheduler 6-3 of a destination of the cell as a request signal 6-4-1-6-4-3 for cell sending.

The scheduler 6-3 executes arbitration processing such that cells directed to the same destination are not sent from a plurality of input ports to send out grant signals 6-5-1-6-5-3 indicating to which direction cell sending is allowed to each input. Each input having received the grant signals 6-5-1-6-5-3 outputs a cell to a relevant destination. Simultaneously with output of the grant signals 6-5-1-6-5-3 to each input, the scheduler 6-3 sends a connection setting signal (signal for setting which input and which output should be connected) 6-6 to the crossbar switch, so that a cell sent from each input arrives at a predetermined output port.

FIG. 4 is a diagram showing one example of priority processing at the input buffer type switch.

Shown here is a case where a low-priority cell A and a high-priority cell B are input from the input 1 in this order and the high-priority cell B and the low-priority cell A are output to the output 1 in this order. At each of VOQ 7-1-1-7-1-3 of the respective input ports, VOQ is arranged for each priority, in which a cell is accumulated not only for each destination but also for each priority (illustrated in this example is a case of two priority classes, high priority and low priority). The cell A is stored in a relevant destination queue of the low-priority side VOQ in the VOQ 7-1-1 because it is a low-priority cell and the cell B is stored in a relevant destination queue of the high-priority side VOQ because it is a high-priority cell, so that destinations of the cells are notified to a scheduler 7-3 as a request signal 7-4-1 for cell sending.

Upon receiving, from the scheduler 7-3, a grant signal 7-5-1 indicative of allowance of cell sending to the output port 1, the input port 1 preferentially outputs the cell stored in the high-priority side VOQ. Therefore, the order of input to the port 1 is the cell A and the cell B, while the order of output is reversed, the cell B and the cell A, that is, the cell B is preferentially output over the cell A. Thus, it is a common practice in priority control at a switch to arrange a buffer for each priority which accumulates a cell and when cells with a plurality of priorities are accumulated at the time of cell output, to output the cells in descending order of priority.

FIG. 5 shows an example of a structure of a load-balanced cell switch device in a case where a number N of interfaces are accommodated according to related art. Such a load-balanced cell switch device is recited, for example, in Literature 1 (Isaac Keslassy, “The Load-Balanced Router”, Ph.D. Dissertation, Stanford University, June 2004). In the following, basic operation of a load-balanced cell switch device according to related art will be described.

The load-balanced cell switch device is formed of input interfaces 8-1-1-8-1-N, a preceding stage crossbar switch 8-2, intermediate stage buffers 8-3-1-8-3-N, a succeeding stage crossbar switch 8-4 and output interfaces 8-5-1-8-5-N.

The input interfaces 8-1-1-8-1-N are an interface block for accommodating data of a rate R. The preceding stage crossbar switch 8-2, which is a crossbar switch, has cyclic setting to evenly output (1/N) traffic from the input interfaces 8-1-1-8-1-N to the intermediate stage buffers 8-3-1-8-3-N. In other words, one intermediate stage buffer block will accommodate traffic of the rate R which is 1/N of N×R as a total of data capacities from all the interfaces.

The intermediate stage buffers 8-3-1-8-3-N, which have a VOQ (Virtual Output Queue) structure to execute individual queuing for each output interface as a destination of each cell, processes 1/N the total traffic at one intermediate stage buffer block. Shown in FIG. 5 is a case where the number N of cells are switched from the input interface 8-1-1 to the output interface 8-5-1. The number N of cells output from the input interface 8-1-1 are distributed to the intermediate stage buffers 8- 3-1-8-3-N by the preceding stage crossbar switch 8-2.

The intermediate stage buffers 8-3-1-8-3-N have a VOQ (Virtual Output Queue) structure to execute individual queuing of each cell for each output interface as a destination, so that an arriving cell will be accumulated in a queue directed to the output interface 8-5-1 (in FIG. 5, the top queue of each immediate stage buffer). The cells distributed to the intermediate stage buffers 8-3-1-8-3-N arrive at the output interface 8-5-1 as a destination of the cells by the succeeding stage crossbar switch 8-4.

Thus, by once distributing cells to the intermediate stage buffers 8-3-1-8-3-N intermediate between the input and output interfaces and sending out the cells from the respective intermediate stage buffers to an output interface as an original destination of the cells to distribute loads per one intermediate stage buffer, the load-balanced cell switch device enables a device processing rate to be increased by an increase in the number of accommodated ports and eliminates the need of scheduler processing which is required by an input buffer type switch.

Here, operation of the preceding stage crossbar switch 8-2 and the succeeding stage crossbar switch 8-4 in FIG. 5 will be detailed.

FIG. 6 is a diagram for use in explaining operation of the preceding stage crossbar switch 8-2 in a case where the number N of interfaces is four in FIG. 5. The preceding stage crossbar switch 8-2 is set such that each output port selects each input port in each cell time in a cycle of N (N=4 in FIG. 6) cell time, with an input port selected by the output ports shifted in one cell time each. Therefore, as shown in FIG. 6, input of four cells in succession from each input port with one cell time shifted will result in even output of one cell each of each input port to each output port starting with the output port 1.

FIG. 7 is a diagram for use in explaining operation of the succeeding stage crossbar switch 8-4 in a case where the number N of interfaces is four in FIG. 5. In the example shown in FIG. 7, as a destination port, a ┌1-*┘ cell is assumed to have the output port 1, a ┌2-*┘ cell is assumed to have the output port 2, a ┌3-*┘ cell is assumed to have the output port 3 and a ┌4-*┘ cell is assumed to have the output port 4. The succeeding stage crossbar switch 8-4 is set to allow each output port to select each input port on a cell time basis in a cycle of N (N=4 in FIG. 7) cell time, with an input port selected by the output ports shifted in one cell time. Therefore, as shown in FIG. 7, upon input of a cell from each intermediate stage buffer, cells distributed to the respective intermediate stage buffers will be output to their original destination ports.

Although the foregoing is basic processing of a load-balanced cell switch device, when the numbers of accumulated cells in the intermediate stage buffers in the load-balanced cell switch device are unbalanced (a state where the number of cells accumulated in each intermediate stage buffer varies), the order of cells will be reversed (with respect to cells of the same output interface, the order of cells sent out to the respective intermediate stage buffers from the input interfaces and the order of cells arriving at the output interface are different).

FIG. 8 shows an example where the order is reversed. The present example is premised on that the number of intermediate stage buffers is four and the cells illustrated in the present example are all directed to the same destination (directed to the output 1). In an initial state, only in the intermediate stage buffer 1, one cell (cell A) is accumulated (State 1). In this state, cells 1, 2, 3 and 4 are output from the input interface to intermediate stage buffers 1, 2, 3 and 4, respectively (State 2). Under the condition, only in the intermediate stage buffer 1, two cells are accumulated and in the other intermediate stage buffers, one cell is accumulated each. When in this state, the cells are output one by one from the intermediate stage buffer 1 in order, the cells will arrive at the output 1 in the order of the cells A, 2, 3, 4 and 1, which is a reverse order of cells (State 3). This situation occurs when the number of cells with the same destination accumulated in each intermediate stage buffer is not even. Therefore, the output interface will require reordering processing for restoring the order of cells.

As to the reordering processing, if a maximum cell time difference among cells to be reordered can be defined (for example, in a case where the cells output from the input interface in the order of the cell 1 the cell 2 arrive in a reverse order, that is, the cell 2 arrives first at the output interface, a maximum waiting time for the cell 1 to arrive after the cell 2 arrives), the maximum amount of buffers necessary for the reordering processing can be defined.

As shown in FIG. 9, when a maximum difference in the number of accumulated cells having the same destination which are accumulated in the number N of intermediate stage buffers is assumed to be (A−C) cells, a cell time difference between the output of the cell C and the output of the cell A will be (A−C)×N cell time. Assume that the cells are output from the input interface in the order of the cell C the cell A, an (A−C)×N cell time will be the maximum cell time difference between cells to be reordered, so that the output interface only needs provision of an amount of buffers for reordering processing equivalent to (A−C)×N cells.

Assume, for example, that with respect to one input interface, a maximum value of a difference in the number of accumulated cells among the intermediate stage buffers is M cells, when the number N of interfaces are accommodated, (A−C)=M×N cells holds to have a maximum time difference between cells to be reordered will be M×N² cell time. Therefore, only the output interfaces as many as the amount of buffers for reordering processing, the number of M×N² cells, are required, and when it is necessary to wait longer than an M×N² cell time, determination can be made that there occurs a cell failure after the input interface.

When in priority control, as shown in the example of the input buffer type switch, it is a common system to arrange a buffer individually for each priority class. When applying the system to a load-balanced cell switch device, buffers will be arranged individually for each priority class in the input interfaces 8-1-1-8-1-N and the intermediate stage buffers 8-3-1-8-3-N in FIG. 5.

When an intermediate stage buffer is arranged for each priority class to preferentially send a high-priority cell all the time as shown in FIG. 10, a low-priority cell might be hardly output depending on circumstances. In such a case, a maximum time difference between cells whose cell reordering is required can not be defined, which disables definition of an amount of buffers for reordering processing at the output interface. Also for the same reason, determination of a cell failure will be disabled as well.

As described in the foregoing, as a system of applying priority control to a common fixed-length cell (including a variable length packet formed into a fixed-length cell) switch whose representative is a router, there exists a system, with a buffer provided for each priority, which controls a reading order while taking priority into consideration. Application of processing of reading a higher-order priority cell all the time as priority processing for an intermediate stage buffer of a load-balanced cell switch device, however, causes such problems as follows.

More specifically, with a cell individually stored for each priority in an intermediate stage buffer, execution of processing of reading a high priority cell might cause a situation where a low priority cell is hardly output, so that a maximum time difference between cells whose cell reordering is required can not be defined in the reordering processing at an output interface.

Therefore, an amount of buffers for reordering processing at the output interface can not be defined. Also for the same reason, determination of a cell failure can not be made.

### SUMMARY

An exemplary object of the present invention is to provide a load-balanced cell switch device and a priority control method which enable an amount of buffers for reordering processing at an output interface to be defined and enable determination of a cell failure.

According to an exemplary aspect of the invention, a load-balanced cell switch device including a plurality of input interfaces, a plurality of intermediate stage buffers and a plurality of output interfaces to handle a fixed-length cell with the input interfaces and the intermediate stage buffers, and the intermediate stage buffers and the output interfaces connected in meshes, includes a control unit which controls, in priority control at a number N of the intermediate stage buffers, to allow at least one cell to arrive at the output interface within a fixed time irrespective of priority of the cell.

According to an another exemplary aspect of the invention, a load-balanced cell switch device, includes an input interface having means for managing a cell on a basis of an output interface as a destination and means for evenly distributing a cell to each intermediate stage buffer, a preceding stage crossbar switch having means for executing switching processing of a cell received from the input interface to the each intermediate stage buffer, an intermediate stage buffer having means for managing a received cell on a basis of an output interface as a destination and means for sending a cell to an output interface as a destination, a succeeding stage crossbar switch having means for executing switching processing of a cell received from the intermediate stage buffer to an output interface as a destination, and an output interface having means for managing a cell received from the succeeding stage crossbar switch on a basis of the input interface and reordering processing means for restoring the order of cells when the order of the cells is reversed, wherein the intermediate stage buffer manages a cell on a priority basis and defines the number of cells readable within a fixed time for each priority in question to execute control to allow at least one cell to arrive at the output interface within the fixed time irrespective of the priority of the cell.

According to an another exemplary aspect of the invention, a priority control method of a load-balanced cell switch device including a plurality of input interfaces, a plurality of intermediate stage buffers and a plurality of output interfaces to handle a fixed-length cell with the input interfaces and the intermediate stage buffers, and the intermediate stage buffers and the output interfaces connected in meshes, includes the step of controlling, in priority control at a number N of the intermediate stage buffers, to allow at least one cell to arrive at the output interface within a fixed time irrespective of priority of the cell.

According to an another exemplary aspect of the invention, a priority control method of a load-balanced cell switch device including an input interface having means for managing a cell on a basis of an output interface as a destination and means for evenly distributing a cell to each intermediate stage buffer, a preceding stage crossbar switch having means for executing switching processing of a cell received from the input interface to each the intermediate stage buffer, an intermediate stage buffer having means for managing a received cell on a basis of an output interface as a destination and means for sending a cell to an output interface as a destination, a succeeding stage crossbar switch having means for executing switching processing of a cell received from the intermediate stage buffer to an output interface as a destination, and an output interface having means for managing a cell received from the succeeding stage crossbar switch on a basis of the input interface and reordering processing means for restoring the order of cells when the order of the cells is reversed, the priority control method comprising the step of, at the intermediate stage buffer, managing a cell on a priority basis and defining the number of cells readable within a fixed time for each priority in question to execute control to allow at least one cell to arrive at the output interface within the fixed time irrespective of the priority of the cell.

According to an another exemplary aspect of the invention, a computer readable medium storing a program which executes priority control of a load-balanced cell switch device including a plurality of input interfaces, a plurality of intermediate stage buffers and a plurality of output interfaces to handle a fixed-length cell with the input interface and the intermediate stage buffers, and the intermediate stage buffers and the output interfaces connected in meshes, the program executes processing of controlling, in priority control at a number N of the intermediate stage buffers, to allow at least one cell to arrive at the output interface within a fixed time irrespective of priority of the cell.

### BRIEF DESCRIPTION OF THE DRAWINGS

FIG. 1 is a block diagram showing a structure of a load-balanced cell switch device according to one exemplary embodiment of the present invention;

FIG. 2 is a diagram for use in explaining an example of cell selection processing in a case where priority control is applied to an intermediate stage buffer in the load-balanced cell switch device according to one exemplary embodiment of the present invention;

FIG. 3 is a block diagram showing an example of a structure of an input buffer type switch according to related art;

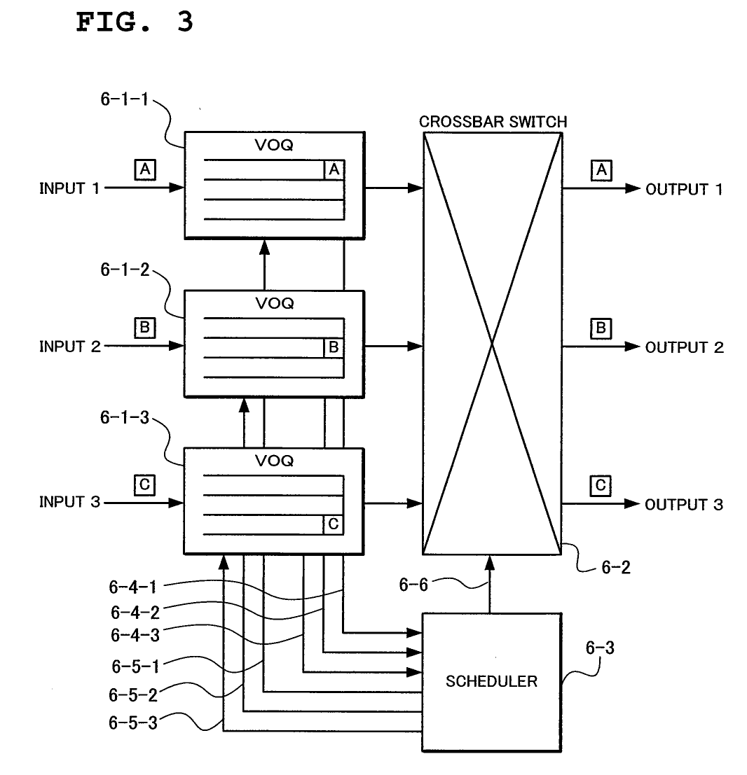

FIG. 4 is a diagram showing an example of a structure of an input buffer type switch according to related art to which priority control is applied;

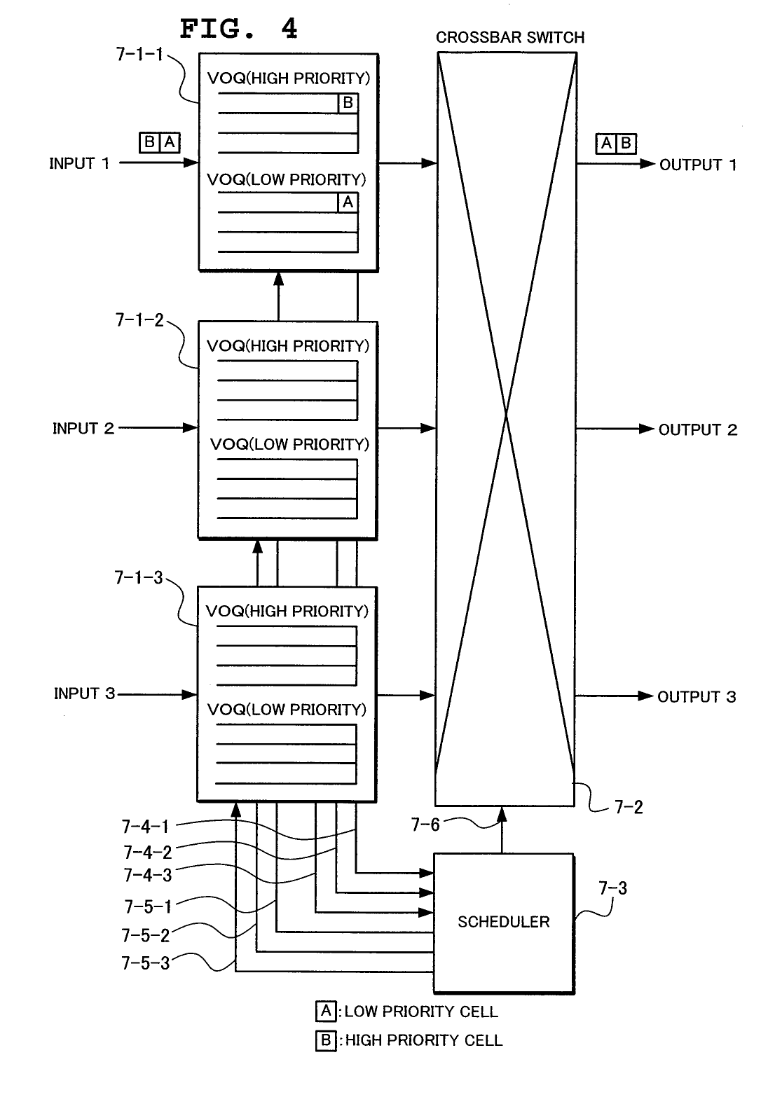

FIG. 5 is a block diagram showing an example of a structure of the load-balanced cell switch device according to related art in a case where the number of accommodated interfaces is N;

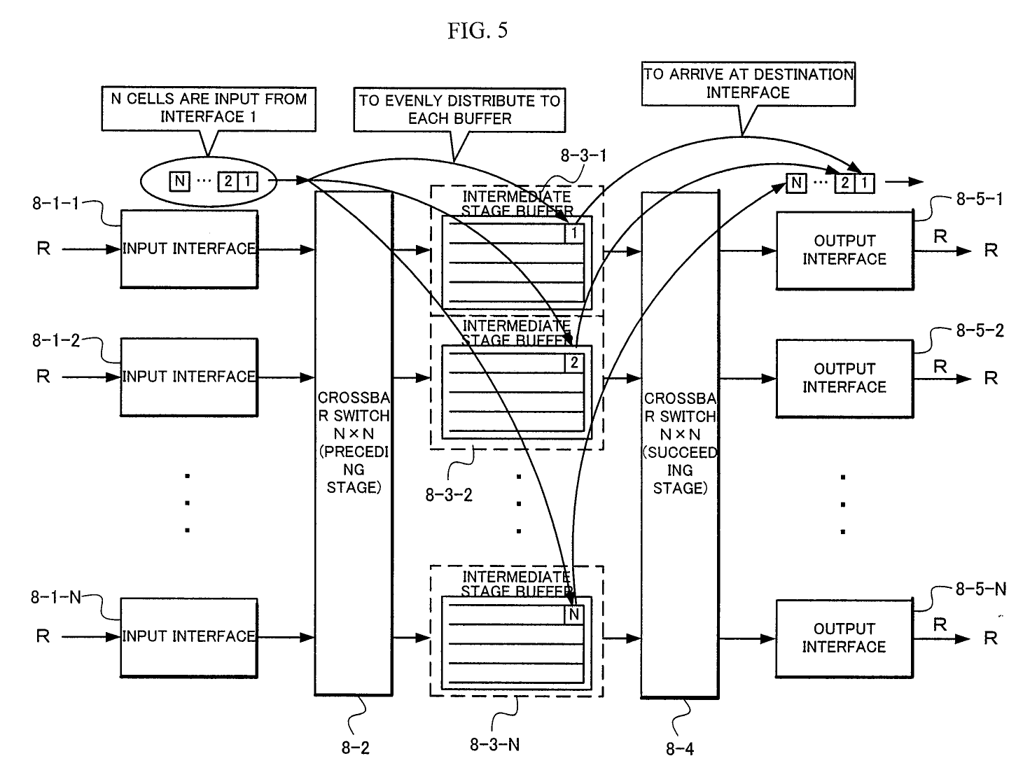

FIG. 6 is a diagram for use in explaining operation of a preceding stage crossbar switch in the load-balanced cell switch device;

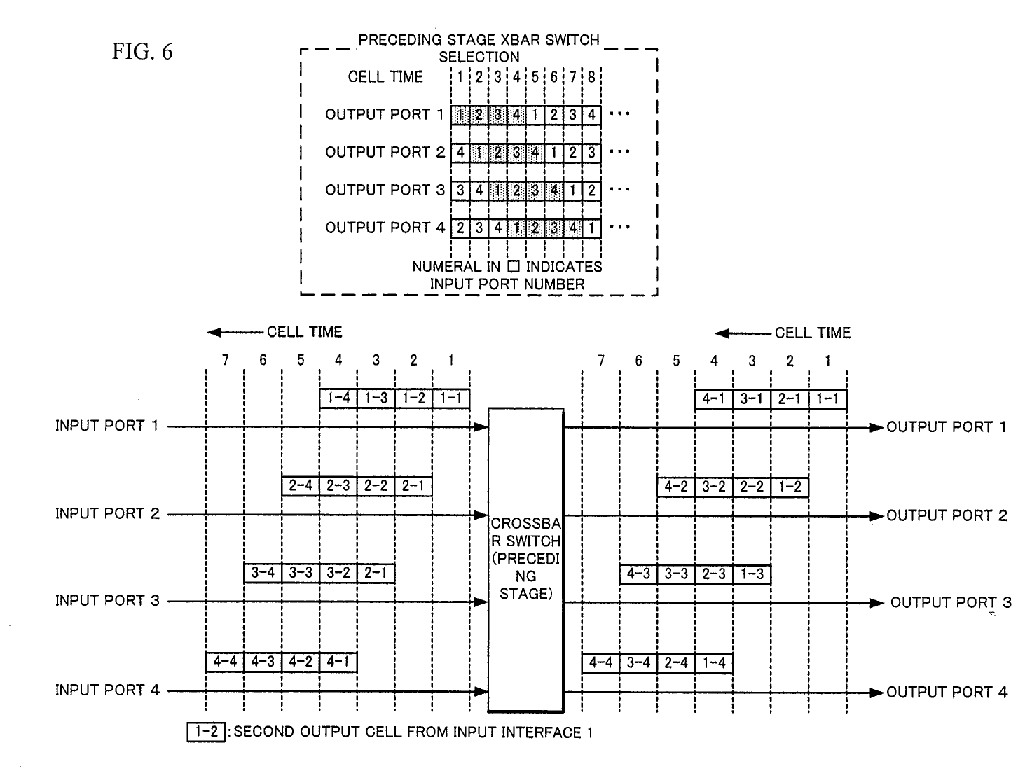

FIG. 7 is a diagram for use in explaining operation of a succeeding stage crossbar switch in the load-balanced cell switch device according to related art;

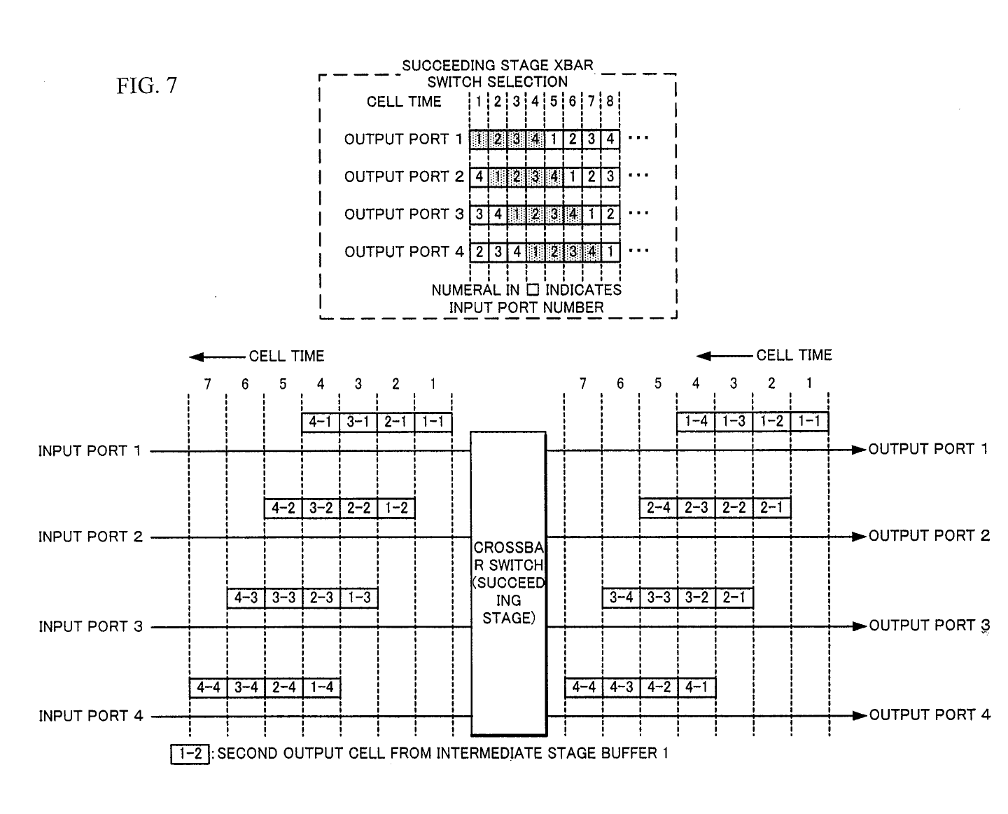

FIG. 8 is a diagram showing an example where the order of cells is reversed at an intermediate stage buffer in the load-balanced cell switch device according to related art;

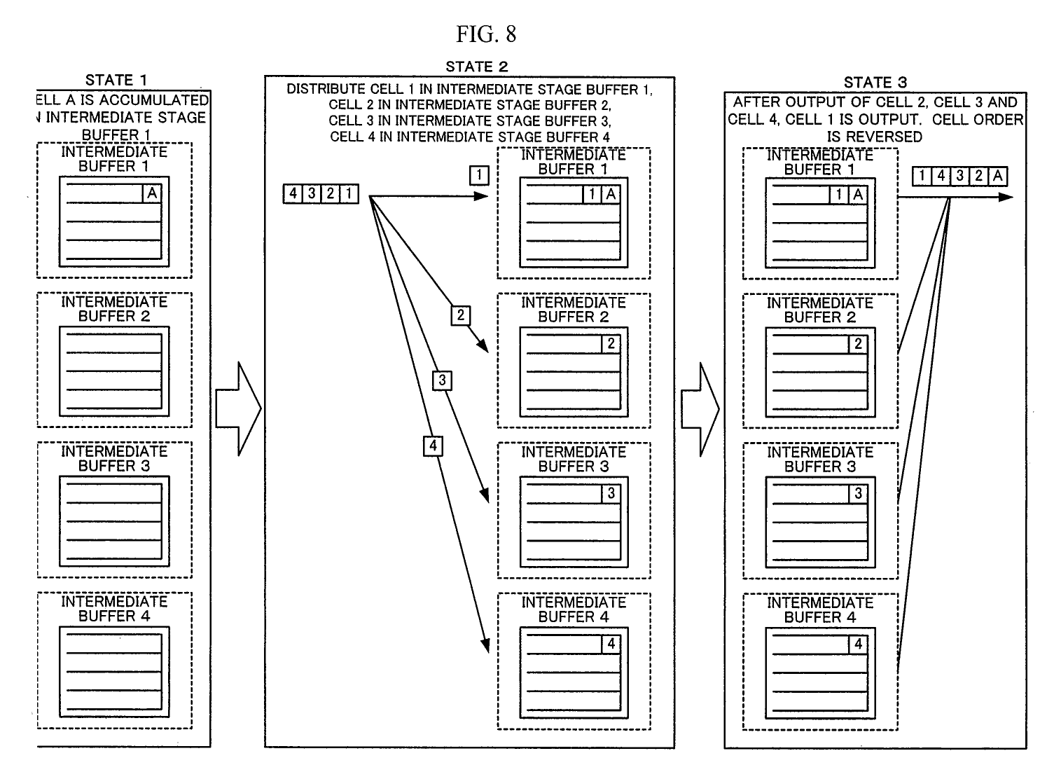

FIG. 9 is a diagram for use in explaining a difference in the number of accumulated cells and an output time difference among the intermediate stage buffers in the load-balanced cell switch device according to related art; and

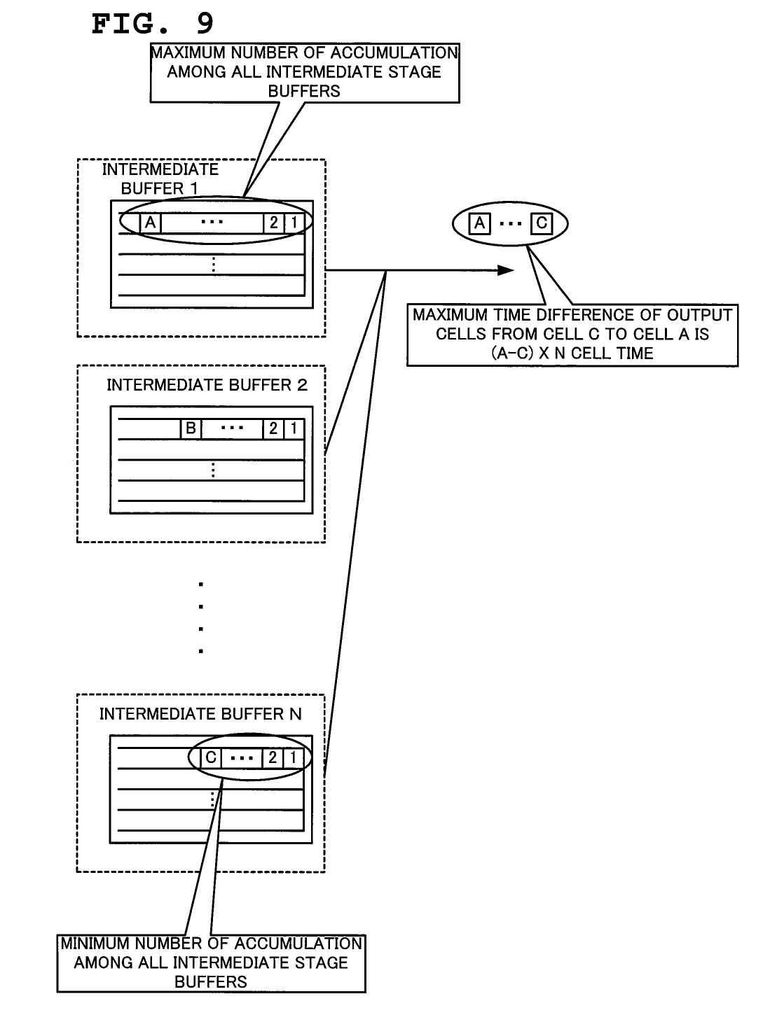

FIG. 10 is a diagram for use in explaining a case where no low priority cell is output when a high priority cell is all the time given preference at the intermediate stage buffer in the load-balanced cell switch device according to related art.

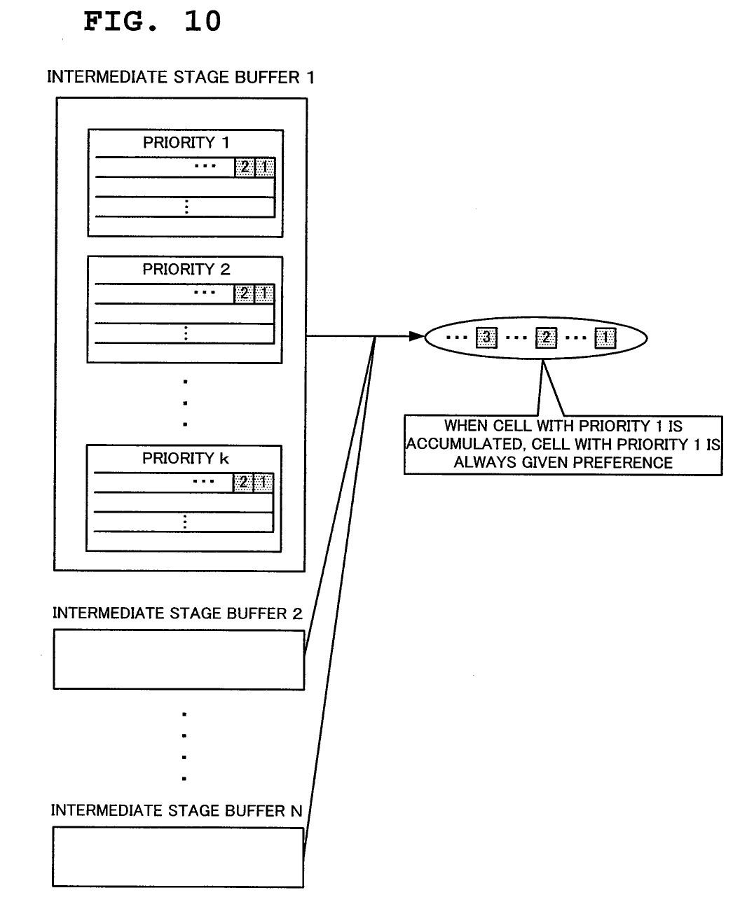

### EXEMPLARY EMBODIMENT

### Description of Structure

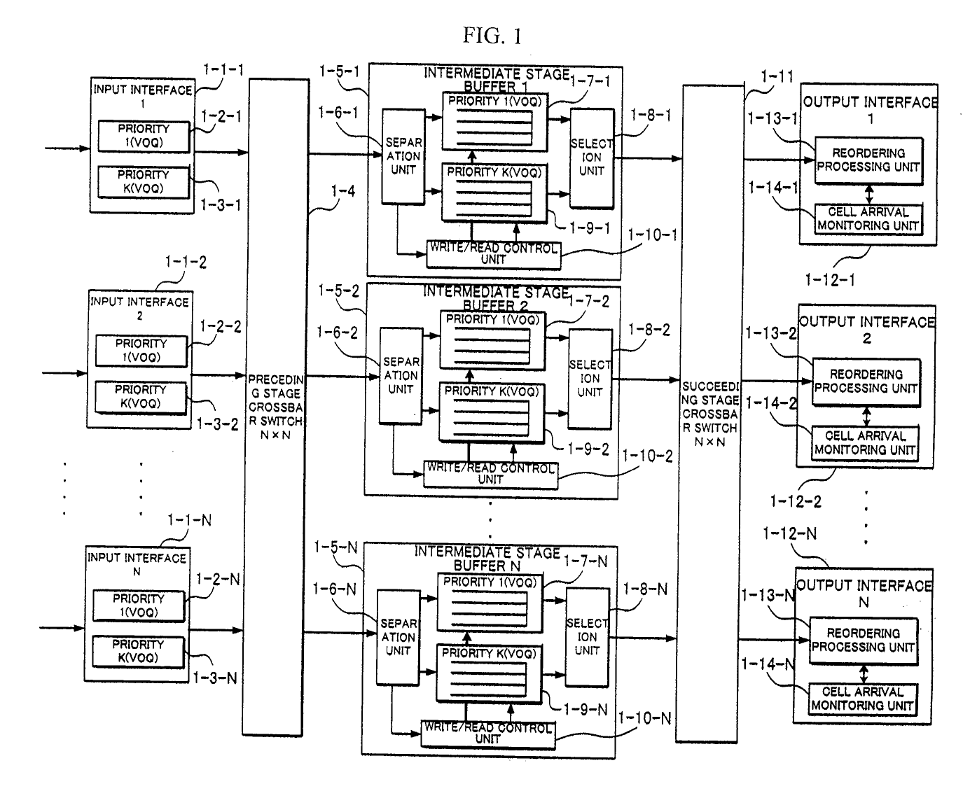

FIG. 1 is a block diagram showing a structure of a load-balanced cell switch device according to an exemplary embodiment of the present invention. FIG. 1 shows a structure in a case where with a number N of input interfaces, the number N of intermediate stage buffers and the number N of output interfaces, the number of priorities is K. N is a positive integer indicative of the number of accommodated ports of the switch.

Although recited here is a case where the number of the input interfaces, that of the intermediate stage buffers and that of the output interfaces are all N, also applicable is a case where the number of the input interfaces, that of the intermediate stage buffers and that of the output interfaces are different from each other. Also assume that to a cell, input interface information, priority and a sequence number are added as header information.

Input interfaces 1-1-1-1-1-N each have a memory (VOQ: Virtual Output Queue) provided therein for accumulating a cell for each destination. The VOQ is arranged individually for each priority (in the present example, priority 1 is assumed to be the highest priority). The accumulated cells are sent out to a preceding stage crossbar switch 1-4 for the distribution to intermediate stage buffers 1-5-1-1-5-N while taking setting timing of the preceding stage crossbar switch 1-4 into consideration. The output cells from the input interfaces 1-1-1-1-1-N are selected by such priority control as preferential output of a higher priority cell.

The preceding stage crossbar switch 1-4, which is a crossbar switch operable with cyclic fixed setting, switches a cell received from the input interfaces 1-1-1-1-1-N according to predetermined setting and outputs the same to the intermediate stage buffers 1-5-1-1-5-N.

The intermediate stage buffers 1-5-1-1-5-N are formed of separation units 1-6-1-1-6-N, VOQ 1-7-1-1- 7-N of priority 1, . . . , VOQ 1-9-1-1-9-N of priority K, read/write control units 1-10-1-1-10-N and selection units 1-8-1-1-8-N, respectively.

The separation units 1-6-1-1-6-N output a cell received from the preceding stage crossbar switch 1-4 to a VOQ of relevant priority (the VOQ 1-7-1-1-7-N of priority 1, . . . , the VOQ 1-9-1-1-9-N of priority K) separately on a priority basis and output priority and destination information of the received cell to the write/read control units 1-10-1-1-10-N.

The write/read control units 1-10-1-1-10-N are blocks for executing write/read control of a cell to/from the VOQ 1-7-1-1-7-N of the priority 1, . . . , and the VOQ 1-9-1-1-9-N of the priority K, and the VOQ 1-7-1-1-7- N of the priority 1, . . . , and the VOQ 1-9-1-1-9-N of the priority K are memories having a VOQ structure for storing a cell on a priority basis.

The selection units 1-8-1-1-8-N select an effective cell output from the VOQ 1-7-1-1-7-N of the priority 1, . . . , the VOQ 1-9-1-1-9-N of the priority K and output the selected cell to a succeeding stage crossbar switch 1-11.

The succeeding stage crossbar switch 1-11, which is a crossbar switch operable with cyclic fixed setting, switches a cell received from the intermediate stage buffers 1-5-1-1-5-N according to predetermined setting and outputs the same to output interfaces 1-12-1-1-12-N.

The output interfaces 1-12-1-1-12-N are formed of reordering processing units 1-13-1-1-13-N and cell arrival monitoring units 1-14-1-1-14-N, respectively.

The reordering processing units 1-13-1-1-13-N execute cell ordering management of a cell received from the succeeding stage crossbar switch 1-11 on a priority basis and on a basis of each of the input interfaces 1-1-1-1-1-N as a transmission source and when the order of cells is reversed, execute reordering processing.

The cell arrival monitoring units 1-14-1-1-14-N monitor a cell waiting time (a time before a cell whose reordering is required arrives, e.g. a waiting time from arrival of a cell having a sequence number 2 until arrival of a cell having a sequence number 1) at the reordering processing units 1-13-1-1-13-N on a priority basis and on a basis of each of the input interfaces 1-1-1-1-1-N as a transmission source and when there exists reordering processing whose time exceeds an expected waiting time, reset the reordering processing.

### Description of Operation

Next, operation of the present exemplary embodiment shown in FIG. 1 will be described. In the present description, assume that the priority 1 is the highest priority and that the priority is descending as priority 2, 3, . . . K (K is a positive integer indicative of the degree of priority). Also assume that to a cell, input interface information, priority and a sequence number are added as header information.

The input interfaces 1-1-1-1-1-N manage a received cell on a priority basis and on a basis of each of output interfaces 1-12-1-1-12-N as a destination and an output cell from the input interfaces 1-1-1-1-1-N is selected by such priority processing as preferential output of a cell on the side of an output interface as a destination or on the higher priority side.

For distributing a selected cell to the intermediate stage buffers 1-5-1-1-5-N, a cell is sent out to the preceding stage crossbar switch 1-4 while taking setting time of the preceding stage crossbar switch 1-4 into consideration. A cell output from each of the input interfaces 1-1-1-1-1-N is subjected to switching processing to the intermediate stage buffers 1-5-1-1-5-N by the preceding stage crossbar switch 1-4.

In the intermediate stage buffers 1-5-1-1-5-N, the received cells are separated on a priority basis and on a basis of an output interface as a destination at the separation units 1-6-1-1-6-N and are written in a predetermined buffer (the VOQ 1-7-1-1-7-N of the priority 1, . . . , the VOQ 1-9-1-1-9-N of the priority K).

Write of a cell to the VOQ 1-7-1-1-7-N of the priority 1, . . . , the VOQ 1-9-1-1-9-N of the priority K is executed by the write/read control units 1-10-1-1-10-N based on an output interface as a destination of a cell received from the separation units 1-6-1-1-6-N and priority information.

The write/read control units 1-10-1-1-10-N also execute read control of a cell from each buffer of the VOQ 1-7-1-1-7-n of the priority 1, . . . , the VOQ 1-9-1-1-9-N of the priority K and also manage the number of accumulated cells at each buffer.

From the intermediate stage buffers 1-5-1-1-5- N, cells directed to each of the output interfaces 1-12-1-1-12-N are output one by one according to setting of the succeeding stage crossbar switch 1-1-1. In other words, from one intermediate stage buffer to one output interface, one cell will be output in an N cell time. Here the “N cell time” will be denoted as “frame” for the sake of explanation.

Although cells are output one by one in one frame time from the intermediate stage buffers 1-5-1-1-5-N to the output interfaces 1-12-1-1-12-N, control of giving preference to a high priority cell all the time will result in preventing sending of a low priority cell. Therefore, for defining a “multi-frame” formed of a plurality of frames to read a cell of each priority at least once within the multi-frame time, executed at the write/read control units 1-10-1-1-10-N is control of cell reading from the VOQ 1-7-1-1-7-N of the priority 1, the VOQ 1-9-1-1-9-N of the priority K.

Controlling as described above enables a maximum delay time to be defined from input of a cell to the intermediate stage buffers 1-5-1-1-5-N to output of the same. For example, noting one input interface and assuming a maximum value of a difference in the number of accumulated cells among the intermediate stage buffers to be M cells, with respect to a cell whose priority is “read once in J frames”, in a case where there exist the number N of interfaces, a maximum time difference between cells whose reordering is required will be J×M×N².

The cells output from the intermediate stage buffers 1-5-1-1-5-N are output to the output interfaces 1-12-1-1-12-N by the succeeding stage crossbar switch 1-11. At the output interfaces 1-12-1-1-12-N, the reordering processing units 1-13-1-1-13-N monitor sequence numbers of arriving cells on a basis of their priority and transmission source input interfaces to execute the reordering processing of reordering the cells according to their sequence numbers.

The cell arrival monitoring units 1-14-1-1-14-N receive a transmission source input interface, priority and a sequence number of a cell arriving from the reordering processing units 1-13-1-1-13-N to execute cell arrival monitoring (e.g. in a case where a cell with the sequence number 2 arrives, while a cell with the sequence number 1 is yet to arrive, to monitor a maximum waiting time from arrival of the sequence number 2 until arrival of the sequence number 1).

When there exists a cell yet to arrive even after a lapse of a maximum cell time of cells whose reordering is required, reset relevant reordering processing (because reordering processing is executed on a cell priority basis and on a transmission source input interface basis, only relevant reordering processing is reset). The maximum cell time of cells whose reordering is required will be executed taking a cell reading cycle for each priority in the intermediate stage buffers 1-5-1-1-5-N into consideration.

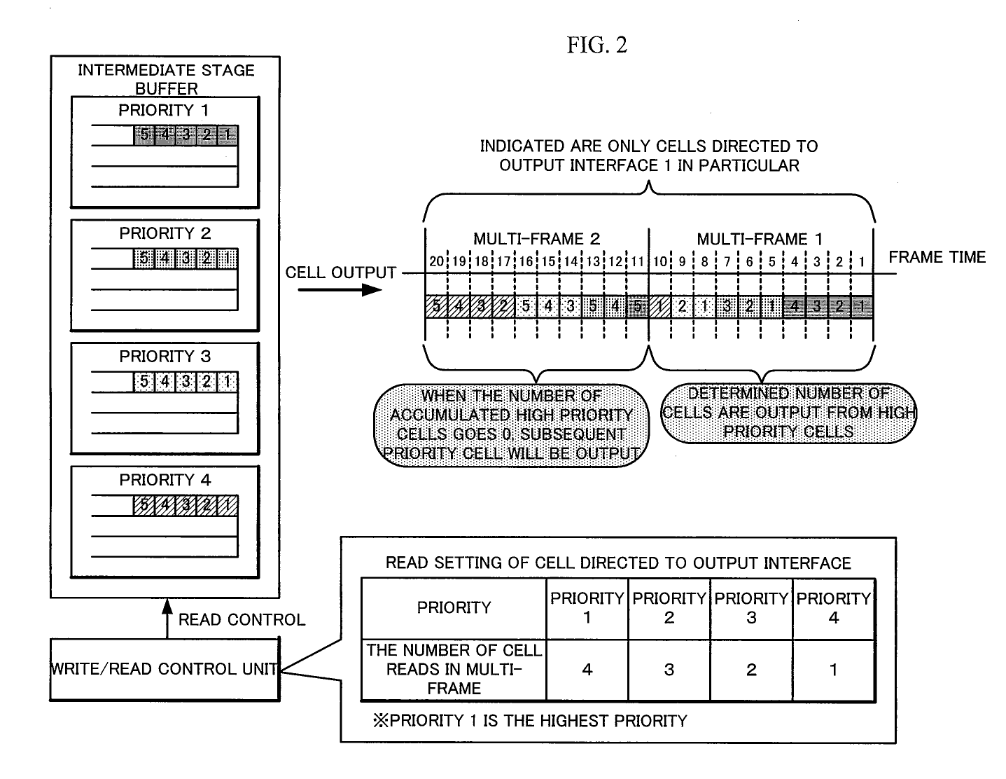

FIG. 2 is a diagram for use in explaining an example of cell selection processing at the intermediate stage buffer in a case of priority 4. The present example is designed, noting cells directed to the output interface 1-12-1, to have 10 frames of a multi-frame, of which at least four cells of the priority 1, three cells of the priority 2, two cells of the priority 3 and one cell of the priority 4 are to be read.

Assume that cells of the respective priorities which are directed to the output interface 1-12-1 are accumulated five cells each, in a frame time 1-10 (multi-frame 1), cells having the priority 1, cells having the priority 2, cells having the priority 3 and cells having the priority 4 will be read four cells, three cells, two cells and one cell, respectively. As a result of the read, the number of accumulated cells of the priority 1 is one cell, that of the priority 2 is two cells, that of the priority 3 is three cells and that of the priority 4 is four cells.

In a frame time 11-20 (multi-frame 2), while cells of the priority 1 can be output four, since the number of accumulated cells is only one cell, only one cell will be output. Right to output three cells yet to be output is handed over to the priority 2.

Although cells of the priority 2 can be output six including those handed over, since the number of accumulated cells is two, only two cells will be output and a right to output the four cells yet to be output is handed over to the priority 3.

Although cells of the priority 3 can be output six including those handed over, since the number of accumulated cells is three, only three cells will be output and a right to output the three cells yet to be output is handed over to the priority 4.

Although cells of the priority 4 can be output four including those handed over, since the number of accumulated cells is four, four cells will be output. This arrangement enables at least one cell of each priority to be output within a fixed time period.

While shown in this example is a case where when there is no accumulation of a higher priority cell, a cell output right will be handed over to one-lower priority, other method is applicable as distribution of a right to output a cell of priority having no accumulation as long as at least one cell of each priority can be output within a fixed time period.

For the application of priority control to a common fixed-length cell (including a variable-length packet formed into a fixed-length cell) switch whose representative is a router, there exists a system for controlling a reading order while taking priority each set for a buffer to be mounted into consideration.

In a case of application of such priority control to a load-balanced cell switch device, with a cell stored for each priority in an intermediate stage buffer, when executing processing of reading higher priority cell, a lower priority cell might be hardly output, so that a maximum time difference among cells whose reordering is required in the reordering processing at the output interface can not be defined. Therefore, an amount of buffers for reordering processing at the output interface can not be defined and also for the same reason, determination of a cell failure can not be made either.

In the exemplary embodiment of the present invention, even when applying priority control to a load-balanced cell switch device, a maximum time difference among cells whose reordering is required in the reordering processing at the output interface can be defined (an amount of buffers for the reordering processing can be also defined) and a load-balanced cell switch device enabling a cell failure determination can be realized.

The load-balanced cell switch device according to the present exemplary embodiment can be realized by the same hardware structure as that of a common computer device comprising a CPU and a memory. More specifically, by executing a program which provides each function of the control unit of the intermediate stage buffer, and the reordering processing unit and the cell arrival checking unit of the output interface described above by the CPU of the computer device, these functions can be realized in software.

As described in the foregoing, in cell read from a buffer for each priority provided in the intermediate stage buffer, the exemplary embodiment controls to read a cell within a fixed time period even from a low priority buffer and to individually monitor, at the output interface, cell arrival at the intermediate stage buffer on a priority basis and on an input interface basis while taking a cell reading cycle into consideration.

A buffer is provided for each priority in the intermediate stage buffer and the number of cells which can be read within a multi-frame (N frame, N: the number of accommodated interfaces) time is determined for each priority in advance to enable at least one cell, even the lowest priority cell, to be read. Since such arrange enables a maximum amount of delay at the intermediate stage buffer to be defined, a maximum amount of delay can be defined while taking priority at the intermediate stage buffer into consideration. In addition, in cell failure determination at the output interface, by monitoring cell arrival while individually taking the maximum amount of delay at the intermediate stage buffer for each priority into consideration, a cell failure at the output interface can be monitored.

Even when applying priority control to a load-balanced cell switch device, the exemplary embodiment enables a maximum cell time difference among cells whose reordering is required by the reordering processing at the output interface to be defined (the amount of buffers for the reordering processing can be also defined) and realizes a load-balanced cell switch device enabling cell failure determination.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INCORPORATION BY REFERENCE

This application is based upon and claims the benefit of priority from Japanese patent application No. 2007-083947, filed on Mar. 28, 2007, the disclosure of which is incorporated herein in its entirety by reference.

1. A load-balanced cell switch device including a plurality of input interfaces, a plurality of intermediate stage buffers and a plurality of output interfaces to handle a fixed-length cell with the input interfaces and the intermediate stage buffers, and the intermediate stage buffers and the output interfaces connected in meshes, comprising:
a control unit which controls, in priority control at a number N of said intermediate stage buffers, to allow at least one cell to arrive at the output interface within a fixed time irrespective of priority of said cell.

2. The load-balanced cell switch device according to claim 1, wherein
said output interface includes means for monitoring cell arrival taking a reading cycle determined for each priority in said intermediate stage buffer into consideration to reset cell reordering processing determined to have a cell failure.

3. The load-balanced cell switch device according to claim 1, wherein said output interface including:
a reordering processing unit which executes cell order management of a received cell on a priority basis and on a sending source input interface basis and executes reordering processing when the cell order is reversed; and
a cell arrival checking unit which monitors a cell waiting time at said reordering processing unit on a priority basis and on a sending source input interface basis and when there exists reordering processing whose expected waiting time has elapsed, resets the relevant reordering processing.

4. A load-balanced cell switch device, comprising:
an input interface having means for managing a cell on a basis of an output interface as a destination and means for evenly distributing a cell to each intermediate stage buffer;
a preceding stage crossbar switch having means for executing switching processing of a cell received from said input interface to said each intermediate stage buffer;
an intermediate stage buffer having means for managing a received cell on a basis of an output interface as a destination and means for sending a cell to an output interface as a destination;
a succeeding stage crossbar switch having means for executing switching processing of a cell received from said intermediate stage buffer to an output interface as a destination; and
an output interface having means for managing a cell received from said succeeding stage crossbar switch on a basis of said input interface and reordering processing means for restoring the order of cells when the order of the cells is reversed; wherein
said intermediate stage buffer manages a cell on a priority basis and defines the number of cells readable within a fixed time for each priority in question to execute control to allow at least one cell to arrive at said output interface within the fixed time irrespective of the priority of said cell.

5. The load-balanced cell switch device according to claim 4, wherein
said output interface monitors cell arrival taking a reading cycle determined for each priority in said intermediate stage buffer into consideration to reset cell reordering processing determined to have a cell failure.

6. The load-balanced cell switch device according to claim 4, wherein
said output interface including:
a reordering processing unit for executing cell order management of a cell received from said succeeding stage crossbar switch on a priority basis and on a sending source input interface basis and executing reordering processing when the cell order is reversed; and
a cell arrival checking unit for monitoring a cell waiting time at said reordering processing unit on a priority basis and on a sending source input interface basis and when there exists reordering processing whose expected waiting time has elapsed, resetting the relevant reordering processing.

7. A priority control method of a load-balanced cell switch device including a plurality of input interfaces, a plurality of intermediate stage buffers and a plurality of output interfaces to handle a fixed-length cell with the input interfaces and the intermediate stage buffers, and the intermediate stage buffers and the output interfaces connected in meshes, comprising the step of:
controlling, in priority control at a number N of said intermediate stage buffers, to allow at least one cell to arrive at the output interface within a fixed time irrespective of priority of said cell.

8. The priority control method of a load-balanced cell switch device according to claim 7, further comprising the step of, at said output interface, monitoring cell arrival taking a reading cycle determined for each priority at said intermediate stage buffer into consideration to reset cell reordering processing determined to have a cell failure.

9. The priority control method of a load-balanced cell switch device according to claim 7, comprising the steps of: at said output interface,
executing cell order management of a received cell on a priority basis and on a sending source input interface basis and executing reordering processing when the cell order is reversed; and
monitoring a cell waiting time in said reordering processing on a priority basis and on a sending source input interface basis and when there exists reordering processing whose expected waiting time has elapsed, resetting the relevant reordering processing.

10. A priority control method of a load-balanced cell switch device including an input interface having means for managing a cell on a basis of an output interface as a destination and means for evenly distributing a cell to each intermediate stage buffer, a preceding stage crossbar switch having means for executing switching processing of a cell received from said input interface to each said intermediate stage buffer, an intermediate stage buffer having means for managing a received cell on a basis of an output interface as a destination and means for sending a cell to an output interface as a destination, a succeeding stage crossbar switch having means for executing switching processing of a cell received from said intermediate stage buffer to an output interface as a destination, and an output interface having means for managing a cell received from said succeeding stage crossbar switch on a basis of said input interface and reordering processing means for restoring the order of cells when the order of the cells is reversed, said priority control method comprising the step of:
at said intermediate stage buffer, managing a cell on a priority basis and defining the number of cells readable within a fixed time for each priority in question to execute control to allow at least one cell to arrive at said output interface within the fixed time irrespective of the priority of said cell.

11. The priority control method of a load-balanced cell switch device according to claim 10, comprising the step, at said output interface, of monitoring cell arrival taking a reading cycle determined for each priority in said intermediate stage buffer into consideration to reset cell reordering processing determined to have a cell failure.

12. The priority control method of a load-balanced cell switch device according to claim 10, comprising the steps of: at said output interface,
executing cell order management of a cell received from said succeeding stage crossbar switch on a priority basis and on a sending source input interface basis and executing reordering processing when the cell order is reversed; and
monitoring a cell waiting time in said reordering processing on a priority basis and on a sending source input interface basis and when there exists reordering processing whose expected waiting time has elapsed, resetting the relevant reordering processing.

13. A computer readable medium storing a program which executes priority control of a load- balanced cell switch device including a plurality of input interfaces, a plurality of intermediate stage buffers and a plurality of output interfaces to handle a fixed-length cell with the input interface and the intermediate stage buffers, and the intermediate stage buffers and the output interfaces connected in meshes, said program executes processing of:
controlling, in priority control at a number N of said intermediate stage buffers, to allow at least one cell to arrive at the output interface within a fixed time irrespective of priority of said cell.

14. The computer readable medium according to claim 13, wherein said program executes processing of: at said output interface,
monitoring cell arrival taking a reading cycle determined for each priority in said intermediate stage buffer into consideration to reset cell reordering processing determined to have a cell failure.

15. The computer readable medium according to claim 13, said program executes processing of: at said output interface,
executing cell order management of a received cell on a priority basis and on a sending source input interface basis and executing reordering when the cell order is reversed; and
monitoring a cell waiting time in said reordering processing on a priority basis and on a sending source input interface basis and when there exists reordering processing whose expected waiting time has elapsed, resetting the relevant reordering processing.
